(19) United States
(12) Patent Application Publication
(10) Pub. No.: US 2013/0198150 A1
(43) Pub. Date: Aug. 1, 2013

(54) FILE-TYPE DEPENDENT DATA DEDUPLICATION

(71) Applicants: SANG-MOK KIM, SEOUL (KR); KYUNG-HO KIM, SEOUL (KR); HYUN-CHUL PARK, ANSAN-SI (KR); O-TAE BAE, DONG-GU (KR); JEONG-HOON JEONG, YONGIN-SI (KR)

(72) Inventors: SANG-MOK KIM, SEOUL (KR); KYUNG-HO KIM, SEOUL (KR); HYUN-CHUL PARK, ANSAN-SI (KR); O-TAE BAE, DONG-GU (KR); JEONG-HOON JEONG, YONGIN-SI (KR)

(73) Assignee: SAMSUNG ELECTRONICS CO., LTD., SUWON-SI (KR)

(21) Appl. No.: 13/613,471

(22) Filed: Sep. 13, 2012

(30) Foreign Application Priority Data
Jan. 30, 2012 (KR) 10-2012-0009067

(51) Int. Cl. G06F 17/30

(52) U.S. Cl. 707/692; 707/E17.005

(57) ABSTRACT

A memory system comprises a pre-processor that receives a data file and determines a type of the data file, a chunking module that chunks the data file to produce a plurality of chunks, a hash engine that generates a hash value for a chunk among the plurality of chunks, a finger print detector that determines whether the hash value matches an entry within a portion of an index table corresponding to the type of the data file, and a storage medium that stores the chunk or a pointer to the chunk according to a result of the determination performed by the finger print detector.

### CROSS-REFERENCE TO RELATED APPLICATIONS

This application claims priority under 35 U.S.C. §119 to Korean Patent Application No. 10-2012-0009067 filed on Jan. 30, 2012, the subject matter of which is hereby incorporated by reference.

### BACKGROUND OF THE INVENTION

The inventive concept relates generally to electronic memory technologies. More particularly, the inventive concept relates to techniques for performing data deduplication in memory systems.

Data deduplication is a technique that reduces the amount of occupied storage space in a memory device or system by eliminating redundant data. As an example, a mail server may perform data deduplication to eliminate redundant copies of an email attachment that has been sent to multiple accounts associated with the mail server. Data deduplication typically involves storing a single unique copy of a unit of data and replacing each redundant copy of the data with a pointer to the unique copy.

In many systems, data deduplication is performed in units referred to as “chunks”. For example, a system may divide input data into multiple chunks, determine whether any of the chunks are identical to each other or to data already stored in the system, and remove redundant chunks based on the determination.

One shortcoming of data deduplication is that it tends to increase the operating overhead of a system. In other words, processing time is required to perform data deduplication, which may potentially reduce the overall performance of the system.

### SUMMARY OF THE INVENTION

In one embodiment of the inventive concept, a system comprises a pre-processor that receives a data file and determines a type of the data file, a chunking module that chunks the data file to produce a plurality of chunks, a hash engine that generates a hash value for a chunk among the plurality of chunks, a finger print detector that determines whether the hash value matches an entry within a portion of an index table corresponding to the type of the data file, and a storage medium that stores the chunk or a pointer to the chunk according to a result of the determination performed by the finger print detector.

In another embodiment of the inventive concept, a method of performing data deduplication comprises determining a type of an input data file, and performing deduplication on the data file by a first method if the data file is of a first type, and performing deduplication of the data file by a second method if the data file is of a second type different from the first type.

In another embodiment of the inventive concept, a method of performing data deduplication comprises generating a plurality of chunks from an input data file using a first method or a second method according to a type of the input data file, determining whether a copy of a selected chunk among the plurality of chunks is already stored in a storage medium, and selectively storing the selected chunk in the storage medium according to a result of the determination.

These and other embodiments of the inventive concept can potentially perform data deduplication with greater efficiency compared with conventional technologies.

### BRIEF DESCRIPTION OF THE DRAWINGS

The drawings illustrate selected embodiments of the inventive concept. In the drawings, like reference numbers indicate like features.

FIG. 1 is a block diagram of a memory system comprising a data deduplication system according to an embodiment of the inventive concept.

FIG. 2 is a block diagram of the data deduplication system of FIG. 1 according to an embodiment of the inventive concept.

FIG. 3 is a flowchart illustrating a method of performing data deduplication according to an embodiment of the inventive concept.

FIG. 4 is a graph illustrating data redundancy of different types of files according to an embodiment of the inventive concept.

FIG. 5 is a block diagram of the data deduplication system of FIG. 1 according to another embodiment of the inventive concept.

FIG. 6 is a flowchart illustrating a method of performing data deduplication according to another embodiment of the inventive concept.

FIG. 7 is a block diagram of a memory system comprising a data deduplication system according to another embodiment of the inventive concept.

FIG. 8 is a block diagram of a memory system comprising a data deduplication system according to still another embodiment of the inventive concept.

FIG. 9 is a block diagram of a memory system according to an embodiment of the inventive concept.

FIG. 10 is a block diagram of a memory system according to another embodiment of the inventive concept.

FIG. 11 is a block diagram of a computing system including the memory system of FIG. 10 according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms “a”, “an”, “the”, and similar referents shall encompass the singular and the plural forms, unless indicated to the contrary. Terms such as “comprising”, “having”, “including”, “containing”, etc., are to be construed as open-ended terms unless indicated to the contrary.

The terms first, second, etc. may be used herein to describe various features, but the described features are not to be limited by these terms. Rather, these terms are used merely to distinguish between different features. Accordingly, a first feature discussed below could be termed a second feature, and vice versa, without changing the meaning of the relevant description.

The term “module”, as used herein, refers to, but is not limited to, a software component, a hardware component, or a combination thereof, such as a Field Programmable Gate Array (FPGA) or Application Specific Integrated Circuit (ASIC), which performs certain tasks. A module may reside in an addressable storage medium and be executed on one or more processors. For example, a module may include, for instance, software components, object-oriented software components, class components, and task components, processes, functions, attributes, procedures, subroutines, segments of program code, drivers, firmware, microcode, circuitry, data, databases, data structures, tables, arrays, and variables. The functionality provided by these features may be combined into fewer components or separated into further components. In other words, the functionality defined by a module can be partitioned in fairly arbitrary ways between various hardware components, software components, etc.

Unless defined otherwise, all technical and scientific terms used herein have the same meaning as commonly understood by one of ordinary skill in the art. The use of any and all examples, or example terms provided herein is intended merely to better illuminate the inventive concept and is not to limit the scope of the inventive concept. Further, unless indicated otherwise, terms defined in generally used dictionaries are not to be interpreted in an overly formal sense.

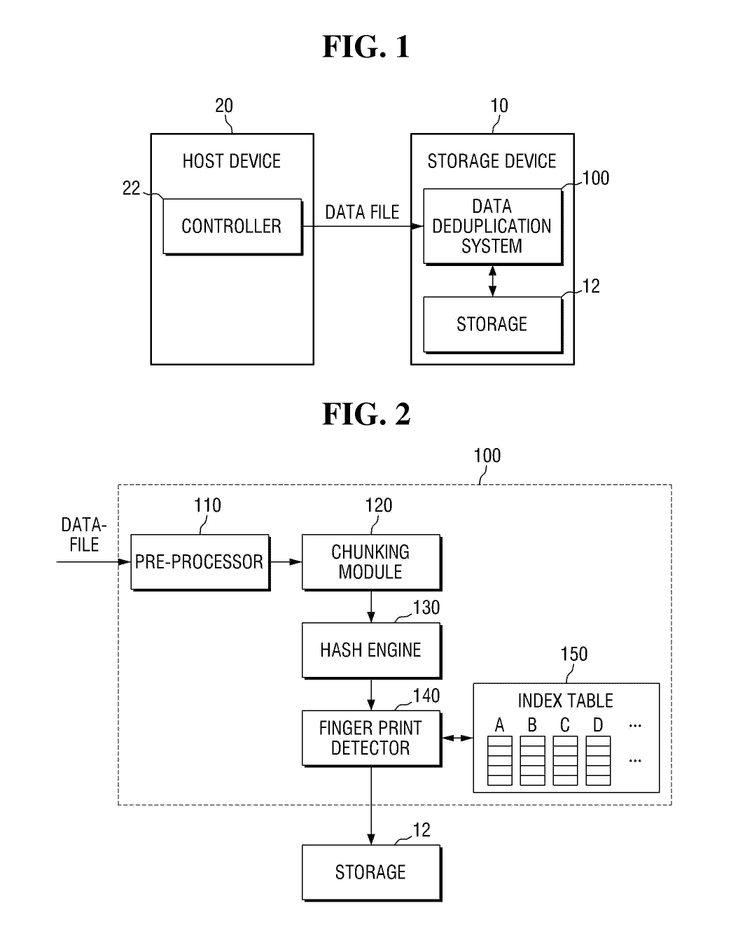

FIG. 1 is a block diagram of a memory system comprising a data deduplication system according to an embodiment of the inventive concept. FIG. 2 is a block diagram of the data deduplication system of FIG. 1 according to an embodiment of the inventive concept.

Referring to FIG. 1, the memory system comprises a host device 20 and a storage device 10. Host device 20 comprises a controller 22 that controls transfer of a data file from host device 20 to storage device 10. Storage device 10 comprises a data deduplication system 100 and a storage medium 12. Data deduplication system 100 receives the data file from host device 20, performs data deduplication on the data file, and transfers a resulting deduplicated data file to storage medium 12.

Referring to FIG. 2, data deduplication system 100 comprises a pre-processor 110, a chunking module 120, a hash engine 130, and a finger print detector 140. Pre-processor 110 receives the data file from host device 20 and determines a type of the data file. The data file may have any type, with example file types including a document file (e.g., a doc file, an xls file, or a ppt file), a picture type (e.g., a jpg file or a gif file), a music file (e.g., an mp3 file or a wma file), or a movie file (e.g., an mpeg file or an avi file). Pre-processor 110 may also determine whether the data file is provided in a compressed or uncompressed format.

Chunking module 120 divides the data file into a plurality of chunks in a procedure referred to as “chunking”. Chunking module 120 performs chunking on the data file using one of a first method and a second method according to the type of data file. That is to say, chunking module 120 may employ a different chunking method according to the type of data file received. In some embodiments, the first method comprises content based chunking of the data file and the second method comprises offset based chunking in which the data file is chunked by a predetermined offset from a file starting point. In some embodiments, the first method comprises content defined chunking (CDC) and the second method comprises static chunking (SC).

Hash engine 130 generates a hash value for each chunk. In particular, hash engine 130 applies a predetermined hash function to each chunk chunked by chunking module 120 to generate a hash value of each chunk. The generated hash value for each chunk may be referred to as a finger print of the chunk.

Finger print detector 140 determines whether the hash value of each chunk is already stored in a portion of an index table 150 corresponding to the type of the data file. For example, if the type of the data file received from pre-processor 110 is determined as an A type (e.g., a doc file type), finger print detector 140 determines whether the hash value of each chunk of the input data file exists in a portion “A” of index table 150.

Hash values of the respective chunks for A type data files stored in storage medium 12 are stored in index table 150 corresponding to A type. Therefore, if there is a hash value of a target chunk in index table 150 corresponding to A type, the target chunk is pre-stored in storage medium 12 (e.g., from a previous storage operation). Accordingly, the target chunk is not redundantly stored to storage medium 12, and instead only a pointer to the target chunk is stored in storage medium 12. Where there is no hash value of the target chunk in index table 150 corresponding to A type, the target chunk is not pre-stored in storage medium 12 and the data itself is stored to storage medium 12. In addition, the hash values of index table 150 corresponding to A type are updated.

Finger print detector 140 does not determine whether the hash value of each chunk is stored in other portions of index table 150 corresponding to different types of data files, such as B, C and D types (e.g. one of a jpg file type and an avi file type). In other words, finger print detector 140 inspects only a portion of index table 150 corresponding to the same type as the type of the input data file.

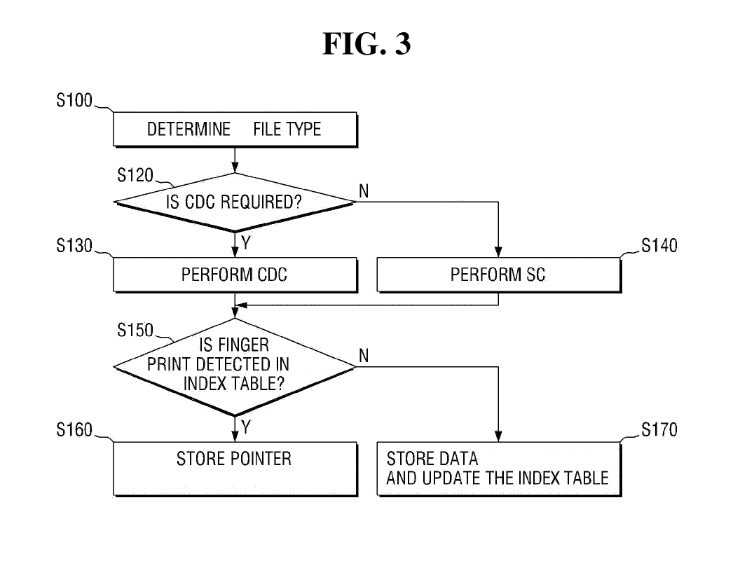

FIG. 3 is a flowchart illustrating a method of performing data deduplication according to an embodiment of the inventive concept. For explanation purposes, it will be assumed that the method is performed by the memory system illustrated in FIGS. 1 and 2. However, the method could alternatively be performed in other types of systems.

Referring to FIG. 3, a type of an input data file is determined (S100). This may be performed by pre-processor 110, for example. In some embodiments, pre-processor 110 determines the data file type by analyzing a pattern of the data file. In some other embodiments, pre-processor 110 receives type information of the data file from host device 20 in as metadata and determines the data file type based on the type information. Nevertheless, the method of determining the data file type is not limited to these examples.

Next, it is determined whether the data file type is a type requiring CDC (S120). Where the data file type is a type requiring CDC (S120=Y), CDC is performed on the data file (S130). Otherwise (S120=N), SC is performed on the data file (S140). In some embodiments, chunking module 120 selects one of CDC and SC according to the data file type and chunks the data file.

Next, a finger print (hash value) of each chunk is generated and it is determined whether the finger print is stored in the index table (S150). If the finger print is stored in the index table, indicating that a corresponding target chunk comprises data that is pre-stored in storage medium 12 (S150=Y), a pointer indicating the data that is pre-stored in storage medium 12 is stored to storage medium 12 (S160). Otherwise (S150=N), the data is stored to storage medium 12 and index table 150 is updated (S170). In some embodiments, hash engine 130 generates a hash value of each chunk, and finger print detector 140 determines whether the hash value of each chunk exists in a portion of index table 150 corresponding to the data file type.

In the embodiment of FIG. 3, the type of the data file received from host device 20 is determined, a chunking method is then determined, and only portions of the index table corresponding to the data file type are inspected. By performing data deduplication based on a data file type, the efficiency of data deduplication can be improved.

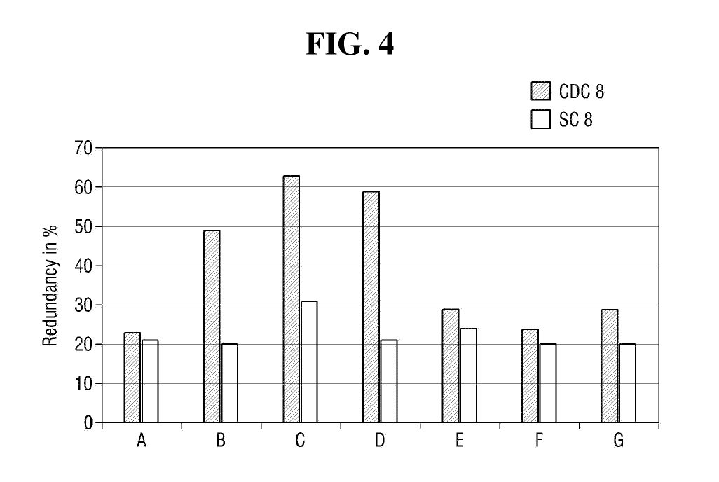

FIG. 4 is a graph illustrating data redundancy of different types of files according to an embodiment of the inventive concept. In FIG. 4, an X axis indicates data file types A to G, and a Y axis indicates a percentage of redundant data of each file type. The label “CDC 8” indicates data redundancy when 8 byte CDC is performed on each data file type and the label “SC 8” indicates data redundancy when 8 byte SC is performed on each data file type.

Referring to FIG. 4, the percentage of data redundancy varies among data file types A to G. In particular, data file types B, C and D have a greater percentage of redundant data than data file types A, E, F and G. One potential reason for these differences in data redundancy is differences in compression rates of the different file types.

In addition, the percentage of redundant data for some file types may be considerably different based on the chunking method used. In particular, data redundancy for data file types B, C and D varies considerably when the chunking method changes from SC8 to CDC8, compared to the data file types A, E, F and G.

Based on the information shown in FIG. 4, where pre-processor 110 determines the input data file type as one of file types B, C and D, data deduplication efficiency can be improved by content based chunking (e.g., CDC), rather than by offset based chunking (e.g., SC). Therefore, as illustrated by FIG. 4, when chunking module 120 changes the chunking method according to the data file type, data deduplication can be performed more efficiently.

In addition, where pre-processor 110 determines the input data file type as one of the file types B, C and D, adequate data deduplication can be performed simply by comparing input data with units of data of the same data file type. By performing data deduplication in this manner, the size of index table 150 can be reduced, and a short time may be required to compare hash values, both of which can improve overall system performance.

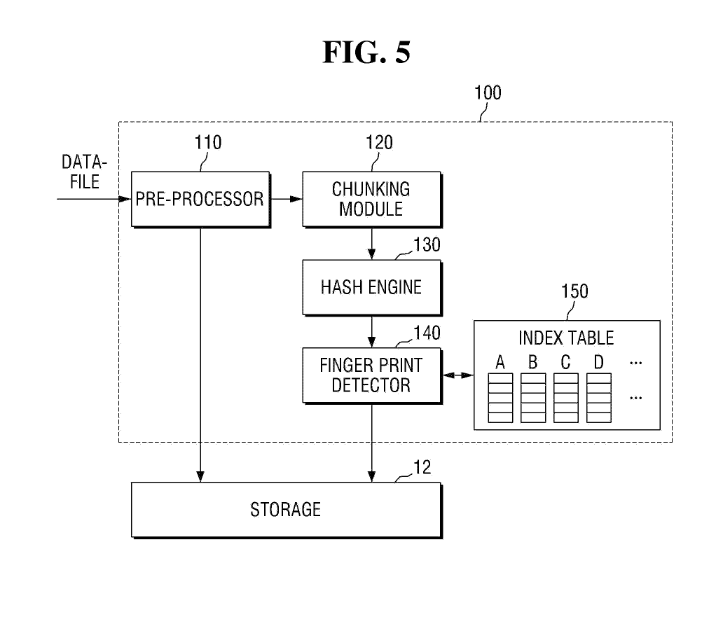

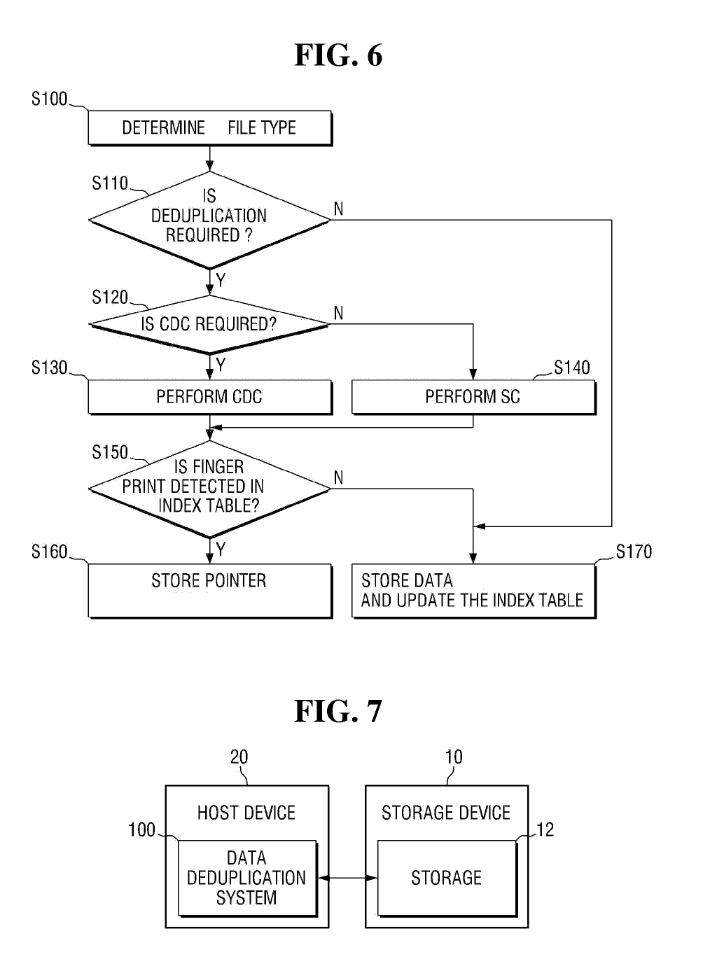

FIG. 5 is a block diagram of data deduplication system 100 according to another embodiment of the inventive concept and FIG. 6 is a flowchart illustrating a method of performing data deduplication according to another embodiment of the inventive concept. Certain features of FIGS. 5 and 6 are similar to features described above, so a description of these features may be abbreviated or omitted in order to avoid redundancy.

Referring to FIG. 5, pre-processor 110 determines whether to perform data deduplication on a data file according to the data file type. This can be performed in an operation S110 of FIG. 6, which represents a difference between the method of FIG. 6 and the method of FIG. 3. As an example, if pre-processor 110 determines the data file type as one of types B, C and D shown in FIG. 4, indicating that the data file has relatively high redundancy, it may be beneficial to perform data deduplication. Otherwise, if the data file type is determined to have redundancy lower than or equal to a threshold value set by a user (for example, 20% or less), the data file may not be subjected to data deduplication, which is more efficient from the viewpoint of system performance. Therefore, in this case, pre-processor 110 may not perform deduplication on the data file supplied from host device 20.

FIG. 7 is a block diagram of a memory system comprising a data deduplication system according to another embodiment of the inventive concept.

Referring to FIG. 7, data deduplication system 100 is disposed within host device 20 rather than storage device 10, and storage medium 12 is disposed within storage device 10. A pre-processor, a chunking module, a hash engine, a finger print detector, and an index table are all disposed within host device 20. These features may be configured similar to those illustrated in FIG. 5, for instance. Host device 20 may have more storage resources compared to storage device 10, which can be used to store a relatively large set of index tables.

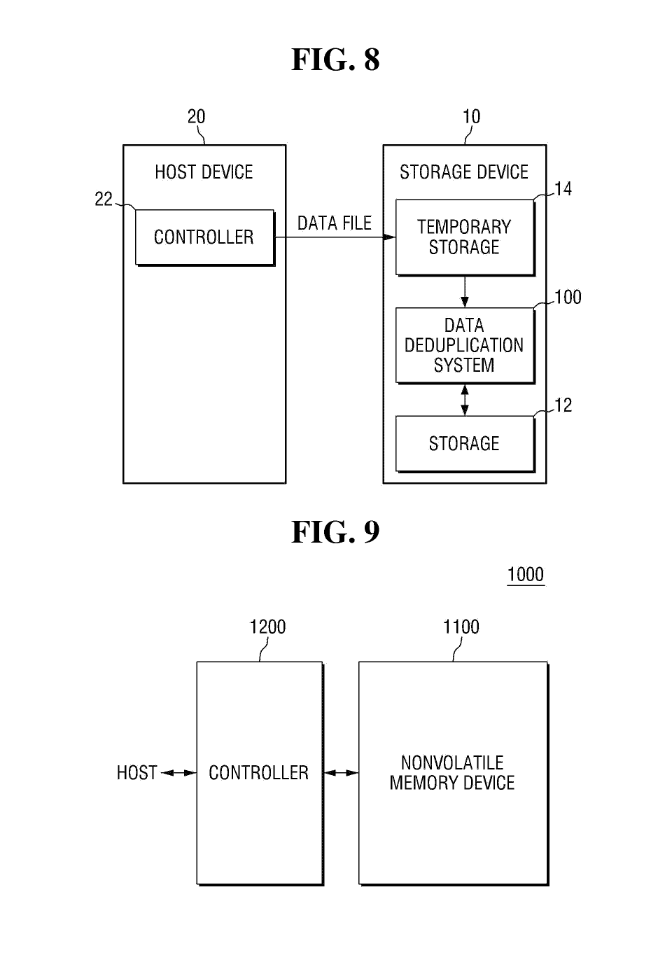

FIG. 8 is a block diagram of a memory system comprising a data deduplication system according to still another embodiment of the inventive concept.

Referring to FIG. 8, the memory system is similar to that of FIG. 1, except that storage device 10 further comprises temporary storage 14. A data file may be supplied from host device 20 to data deduplication system 100 through temporary storage 14.

During typical operation, host device 20 stores the data file in temporary storage 14 of storage device 10, and data deduplication system 100 performs deduplication on the data file stored in temporary storage 14 when storage device 10 is in an idle state. As the result of the data deduplication, data without redundancy with respect to the data stored in storage medium 12 is newly stored in storage medium 12.

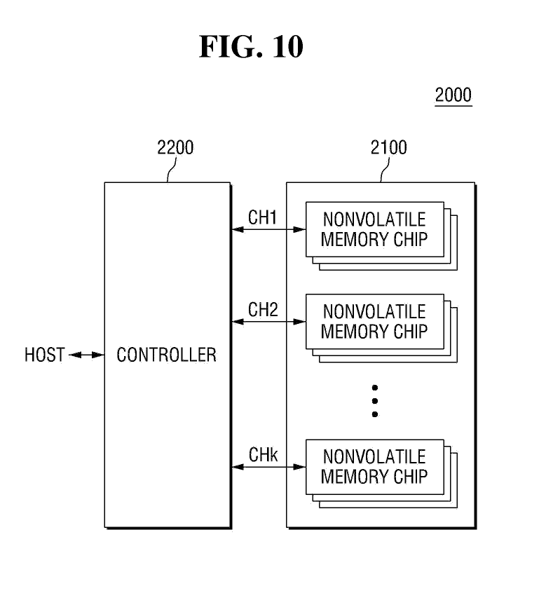

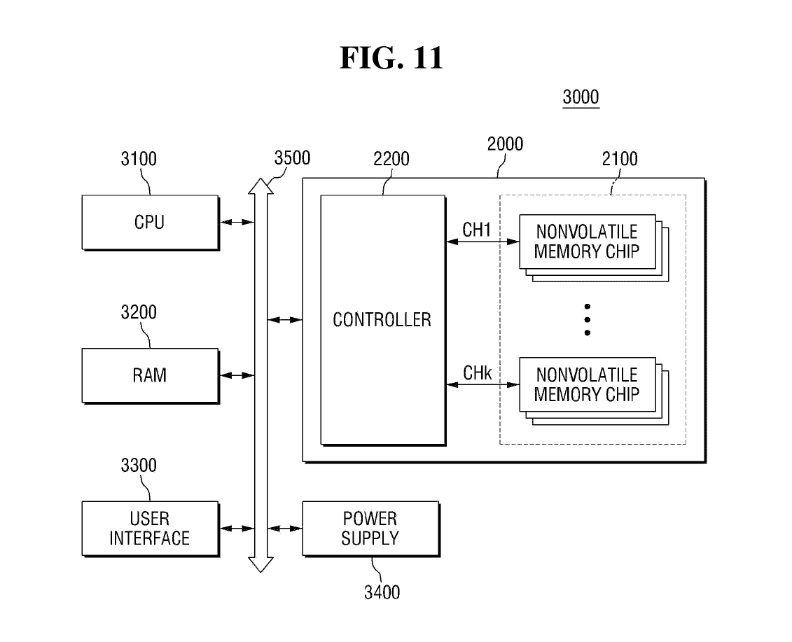

FIG. 9 is a block diagram of a memory system according to an embodiment of the inventive concept, FIG. 10 is a block diagram of a memory system according to another embodiment of the inventive concept, and FIG. 11 is a block diagram of a computing system incorporating the memory system of FIG. 10 according to an embodiment of the inventive concept.

Referring to FIG. 9, memory system 1000 comprises a nonvolatile memory device 1100 and a controller 1200. A data deduplication system as described above in relation to FIGS. 1 through 8 may be disposed in nonvolatile memory device 1100.

Controller 1200 is connected to a host device and a nonvolatile memory device 1100. In response to a request from the host, controller 1200 accesses nonvolatile memory device 1100. For example, controller 1200 is configured to control read, write, erase and background operations of nonvolatile memory device 1100. Controller 1200 is configured to provide interfacing between nonvolatile memory device 1100 and the host. Controller 1200 is configured to drive firmware for controlling nonvolatile memory device 1100.

Controller 1200 typically further comprises well known components such as a random access memory (RAM), a processing unit, a host interface, and a memory interface. The RAM may be used as at least one of an operation memory of the processing unit, a cache memory between nonvolatile memory device 1100 and the host, and a buffer memory between nonvolatile memory device 1100 and the host. The processing unit may control every operation of controller 1200.

The host interface implements a protocol to exchange data between the host and controller 1200. For example, controller 1200 may be configured to communicate with the host through one of various standard interface protocols such as Universal Serial Bus (USB), multimedia card (MMC), peripheral component interconnection (PCI), peripheral component interconnection-express (PCI-E), advanced technology electronics (ATA), serial-ATA, parallel-ATA, small computer small interface (SCSI), enhanced small disk interface (ESDI), and integrated drive electronics (IDE). The memory interface of controller 1200 may interface with nonvolatile memory device 1100. For example, the memory interface may include an NAND interface and an NOR interface.

Memory system 1000 may further comprise an error correction block to detect and correct errors in data read from nonvolatile memory device 1100 using an error correction code (ECC). The error correction block may be provided as a component of controller 1200 or nonvolatile memory device 1100.

Controller 1200 and nonvolatile memory device 1100 can be integrated in one semiconductor device. In an example embodiment, controller 1200 and nonvolatile memory device 1100 may be integrated in one semiconductor device to constitute a memory card. For example, controller 1200 and nonvolatile memory device 1100 may be integrated in one semiconductor device to constitute a PC card (PCMCIA), a compact flash card (CF), a smart media card (SM/SMC), a memory stick, a multimedia card (MMC, RS-MMC, MMCmicro), a SD card (SD, miniSD, microSD), a universal flash memory device (UFS).

In some embodiments, controller 1200 and nonvolatile memory device 1100 are integrated in one semiconductor device to form a solid state disk/drive (SSD). The SSD may include a storage device configured to store data to a semiconductor memory. Where memory system 1000 is used as an SSD, an operation speed of the host connected to memory system 1000 may be improved significantly.

In some embodiments, memory system 1000 may be applied to one of a computer, a portable computer, an Ultra Mobile PC (UMPC), a workstation, a net-book, a Personal Digital Assistant (PDA), a web tablet, a wireless phone, a mobile phone, a smart phone, an e-book, a portable multimedia player (PMP), a portable game device, a navigation device, a black box, a digital camera, a 3-dimensional television, a digital audio recorder, a digital audio player, a digital picture recorder, a digital picture player, a digital video recorder, a digital video player, a device capable of transmitting/receiving data in an wireless environment and various electronic devices constituting a home network, one of various electronic devices constituting a computer network, one of various electronic devices constituting a telematics network, a radio-frequency identification (RFID) device, or one of various constituents constituting a computing system.

Nonvolatile memory device 1100 or memory system 1000 may be packaged using various package types or package configurations, such as Package on Package (PoP), Ball grid arrays (BCAs), Chip Scale Packages (CSPs), Plastic Leaded Chip Carrier (PICC), Plastic Dual in-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System in Package (SIP), Multi Chip Package (MCP), Wafer-level Fabricated Package (WFP), or Wafer-Level Processed Stack Package (WSP).

Referring to FIG. 10, memory system 2000 comprises a nonvolatile memory device 2100 and a controller 2200. Nonvolatile memory device 2100 comprises a plurality of nonvolatile memory chips. The plurality of nonvolatile memory chips are divided into a plurality of groups each configured to communicate with controller 2200 through a common channel. In the illustrated example, the plurality of nonvolatile memory chips may communicate with controller 2200 through first to kth channels CH1 to CHk. Accordingly, each of the plurality of nonvolatile memory chips is connected to a single channel. However, memory system 2000 may be modified to connect one nonvolatile memory chip to one channel.

Referring to FIG. 11, computing system 3000 comprises a central processor unit (CPU) 3100, a random access memory (RAM) 3200, a user interface 3300, a power supply 3400, and a memory system 2000.

Memory system 2000 is electrically connected to CPU 3100, RAM 3200, user interface 3300 and to power supply 3400 through a system bus 3500. The data supplied through user interface 3300 or the data processed by CPU 3100 is stored to memory system 2000. Nonvolatile memory device 2100 is connected to system bus 3500 through controller 2200. However, nonvolatile memory device 2100 may be directly connected to system bus 3500.

Although computing system 3000 is shown with memory system 200 of FIG. 10, it could alternatively include memory system 1000 of FIG. 9, for example. Moreover, in some embodiments, computing system 3000 comprises both of memory systems 1000 and 2000 shown in FIGS. 9 and 10.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A system, comprising:
a pre-processor that receives a data file and determines a type of the data file;
a chunking module that chunks the data file to produce a plurality of chunks;
a hash engine that generates a hash value for a chunk among the plurality of chunks;
a finger print detector that determines whether the hash value matches an entry within a portion of an index table corresponding to the type of the data file; and
a storage medium that stores the chunk or a pointer to the chunk according to a result of the determination performed by the finger print detector.

2. The system of claim 1, wherein the chunking module selects one of a first method and a second method different from the first method according to the type of data file and chunks the data file using the selected method.

3. The system of claim 2, wherein the first method comprises content based chunking and the second method includes offset based chunking.

4. The system of claim 3, wherein the first method comprises content defined chunking (CDC) and the second method comprises static chunking (SC).

5. The system of claim 1, wherein the pre-processor determines whether to perform data deduplication on the data file according to the type of the data file.

6. The system of claim 1, further comprising host that supplies the data file to the pre-processor.

7. The system of claim 6, wherein the pre-processor analyzes a pattern of the data file supplied from the host to determine the type of the data file.

8. The system of claim 6, wherein the host supplies type information of the data file to the pre-processor together with the data file.

9. The system of claim 6, wherein the storage device further comprises temporary storage and the data file is supplied to the pre-processor from the host device through the temporary storage.

10. The system of claim 6, wherein the storage medium comprises a nonvolatile memory device.

11. The system of claim 1, further comprising a host supplying the data file to the pre-processor and incorporating the pre-processor, the chunking module, the hash engine, and the finger print detector, wherein the storage medium is located external to the host.

12. A method of performing data deduplication, comprising:
determining a type of an input data file; and
performing deduplication on the data file by a first method if the data file is of a first type, and performing deduplication of the data file by a second method if the data file is of a second type different from the first type.

13. The method of claim 12, wherein the first method comprises generating a plurality of chunks by chunking the data file, generating a first hash value for a first chunk among the plurality of chunks, and determining whether the first hash value matches an entry within a first portion of an index table corresponding to the first type.

14. The method of claim 13, wherein the second method comprises generating a plurality of chunks by chunking the data file, generating a second hash value for a second chunk among the plurality of chunks, and determining whether the second hash value matches an entry within a second portion of the index table corresponding to the second type.

15. The method of claim 12, wherein the first method comprises content defined chunking (CDC) and the second method includes static chunking (SC).

16. The method of claim 12, further comprising, if the type of the data file is a third type, skipping deduplication of the data file.

17. A method of performing data deduplication, comprising:
generating a plurality of chunks from an input data file using a first method or a second method according to a type of the input data file;
determining whether a copy of a selected chunk among the plurality of chunks is already stored in a storage medium; and
selectively storing the selected chunk in the storage medium according to a result of the determination.

18. The method of claim 17, further comprising storing in the storage medium a pointer to the selected chunk upon determining that a copy of the selected chunk is already stored in the storage medium.

19. The method of claim 17, wherein the first method comprises content defined chunking (CDC) and the second method includes static chunking (SC).

20. The method of claim 17, wherein determining whether a copy of a selected chunk among is already stored in the storage medium comprises generating a hash value for the selected chunk and determining whether the hash value matches a hash value stored in an index table corresponding to the type of the input data file.
